(19) United States
(12) Patent Application Publication
(10) Pub. No.: US 2003/0165690 A1
(43) Pub. Date: Sep. 4, 2003

(54) Color trim panel

(76) Inventors: Kevin Allen Kieltyka, Rochester, MI (US); Srinivas Kotha, Sterling Heights, MI (US)

Correspondence Address: BRINKS HOFER GILSON & LIONE, P.O. BOX 10395, CHICAGO, IL, 60611, US

(21) Appl. No.: 10/091,732

(22) Filed: Mar. 4, 2002

(51) Int. Cl. B32B 27/06

(52) U.S. Cl. 428/422; 428/507; 428/515

(57) ABSTRACT

The present invention provides a door panel insert having an integral cover skin material. The door panel insert comprises a first layer or the decorating layer, a second layer, a recylate layer and a fourth layer. The recylate layer is sandwiched between the second layer and the fourth layer. The first layer is tacked on to the second layer before the molding process such that during compression and heating of the trim panel the first layer is chemically bonded to the second layer.

### TECHNICAL FIELD

This patent discloses and claims a useful, novel, and unobvious invention for a trim panel for use in motor vehicles. More specifically a trim panel formed from natural fiber mat and a method of making such trim panel is disclosed in the present application.

### BACKGROUND

It is known to provide a trim panel assembly for an automotive vehicle to present an aesthetically pleasing appearance in an occupant compartment of the automotive vehicle. Trim panels have typically been used in headliners, instrument panels and doors. The current automotive interior styling trend is toward a softer, wrap-around styling vision which places special emphasis on the tactile feel of the interior, as well as the visual impression. The hard plastic substrates and surfaces of car interiors in past years are being replaced by the trend toward padded or cushioned surfaces, covered by either vinyl or textile materials. The automotive interior surfaces typically comprise a structural substrate of aluminum, plastic or which is relatively rigid. A layer of padding and a trim panel may cover the interior surface of the substrate. The surface of the trim panel which is exposed to the passenger are typically leather, vinyl or textile materials, including cloth or carpet. In addition a layer of foam is inserted between the substrate and the surface that is exposed to give the trim panel a tactile feel.

Current interior trim suppliers are using a variety of methods to apply the layer of exposed surface and padding to the substrates of various interior trim systems. The most common and least technologically advanced method is hand applying the coverings to the substrate. The layers are hand laid over a finished substrate and then pushed, pulled, tucked and pinched into the contour of the substrate. The layers are secured with adhesives and/or mechanical fasteners such as staples or the like. Obviously hand applied trim panels have high labor costs. Yet another method is vacuum forming and low-pressure molding (LPM). In LPM the trim panel is attached concurrently with the molding of the rigid substrate.

However, it is desirable to provide a trim panel assembly with reduced mass, tooling and equipment per vehicle. Therefore, there is a need in the art to provide an improved method of making a trim panel assembly for an automotive vehicle that has an integral cover skin and desired coloring for the trim panel.

### SUMMARY

In one aspect of the present invention, a door panel installed in an interior of a motor vehicle comprises a first layer formed of a first material, a second layer formed of a second material, a third layer formed of a third material and a fourth layer formed of the same material as the second layer. The second and the forth layer are adaptable to be molded such that they form the substrate of the door panel.

In yet another aspect of the present invention, a method of forming a door panel for an interior of a motor vehicle is disclosed. The method comprises forming the second layer and the fourth layer. Sandwiching the third layer between the second layer and the fourth layer. The first layer is then tacked on top of the second layer. The pre-formed layers are then inserted inside a molding tool and heated such that the first layer is integrally attached to the second layer.

### BRIEF DESCRIPTION OF THE FIGURES

FIG. 1 is a perspective view of a door panel insert, according to the preferred embodiment of the present invention; and

FIG. 2 is a cross-sectional view of a portion of the door panel insert, showing the layers of the trim panel thereof in accordance with the preferred embodiment of the present invention; and

### DETAILED DESCRIPTION OF THE PREFERRED EMBODIMENTS

The following description of the preferred embodiments is merely exemplary in nature, and is in no way intended to limit the invention or its application or uses.

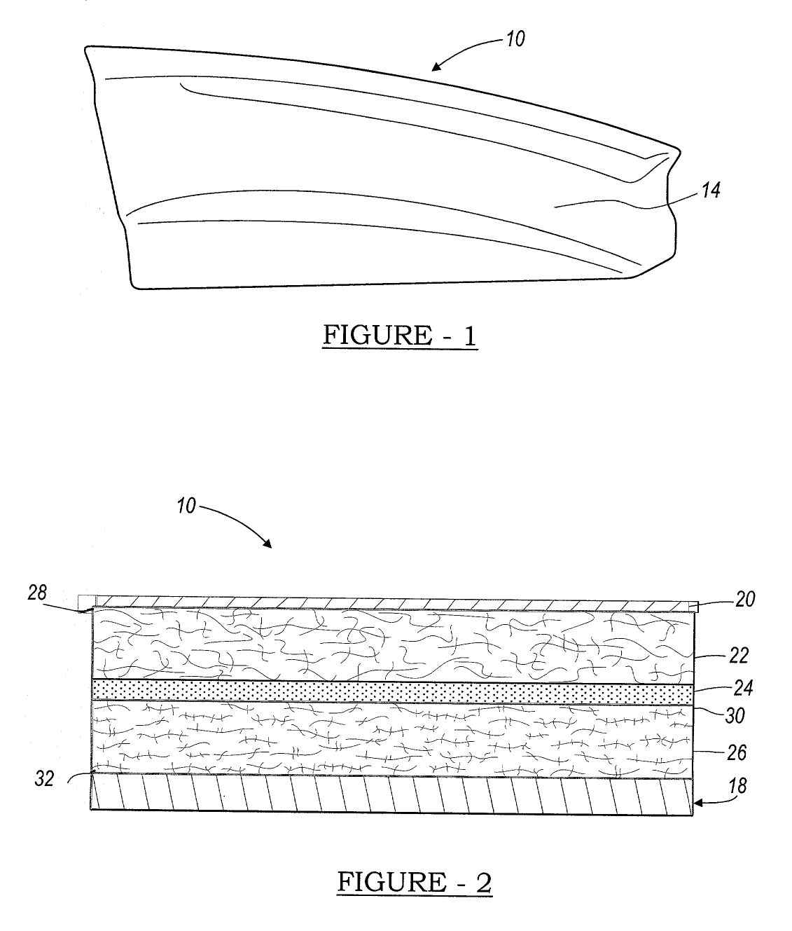

Referring in particular to FIGS. 1 and 2, a door panel insert installed in the interior of a motor vehicle in accordance with the teachings of the present invention is generally designated by reference numeral 10. Although not shown in the drawings the door panel inset 10 is a part of a door of the motor vehicle. The door panel insert 10 defines an exterior surface 14 and is attached to a door panel substrate 18. Alternatively, the door panel insert 10 may be directly attached to a substrate such as an interior metallic sheet made of aluminum or a hard plastic substrate. The exterior surface 14 is exposed to the interior of the motor vehicle and is also known as a Class A surface.

It should be understood that the door panel insert 10 is only illustrated as an example. The insert formed by the method of this invention may be mounted to other panels of the motor vehicle such as instrument panels, headliners, arm rests, center consoles, seating, head rests, A, B or C pillars.

The door panel insert 10 in accordance with the teachings of the present invention is preferably attached to a door panel substrate 18. The door panel substrate 18 is relatively rigid than the door panel insert 10. This method of forming the door panel insert 10 can also be used to form the door panel substrate 18. The door panel insert 10 is attached to the door panel substrate 18 with the help of heat stacking process. Alternatively, the door panel insert 10 can be attached to the door panel substrate 18 with the help adhesives. Preferably, the adhesive used is a thermosetting adhesive such as cross linking urethane such that on heating it bonds the door panel insert 10 to the substrate 18.

The door panel insert 10 comprises a first layer or an outer decorative layer 20, a second layer 22, a third layer 24 and a fourth layer 26. The first layer 20 of the door panel insert 10 forms the exterior surface 14 or the class A surface. As will be explained later, the class A surface or the exterior surface 14 of the door panel insert is simultaneously formed with the formation of the substrate portion 22 and 26 of the door panel insert 10. As discussed above, first layer 20 is exposed to a passenger of the motor vehicle. The fourth layer 26 is attached to the door panel substrate 18. Preferably, the second layer 22 and the third layer 24 are sandwiched between the first layer 20 and the fourth layer 26. Alternatively, it is possible that the trim panel assembly 10 is formed with fever than four layers. For example, the trim panel assembly may be formed only of the first layer 20, the second layer 22.

The first layer 20, as explained above is generally the layer that is exposed to the passenger of the motor vehicle. The first layer 20 is formed of a first material. Preferably, the first material used to form the first layer 20 is extruded polypropylene. The process of obtaining an extruded polypropylene is well known in the art and is not explained in details. Alternatively, the first layer 20 could also be formed of a spun bond polypropylene. As will be explained later in either case, the first layer 20 is bonded to the upper surface 28 of the second layer 22. The thickness of the first layer 20 is determined by the density of the second layer 22. In order to manufacture a trim panel assembly 10 with the desired color, color may be added to polypropylene material. Alternatively, it is also possible to add more than one color to the first layer 20 such that the trim panel assembly 10 has more than one color. Additionally, it is also possible to add or control the grain size of the first layer 20.

The second layer 22 of the trim panel assembly 10 acts as a padding between the door panel substrate 18 and the first layer 20. Additionally, the second layer 22 also serves to impart structural integrality to the trim panel assembly 10. Preferably, the second layer 22 is formed of natural fiber composites. The natural fibers are derived from plants such as kenaf, hemp, flax, jute and sisal. These natural fibers are mixed with polypropylene and/or PET to form the natural fibers composites used in the present invention.

The third layer 24, in accordance with the teaching of the present invention is made of a recyclate material. In this invention by recylate material it is meant any material that can typically be recycled into the environment when the trim panel assembly 10 is removed from the motor vehicle. The process of adding the recylate material to the trim panel assembly 10 is explained in detail later. The third layer 24, is sandwiched between the second layer 22 and the fourth layer 26. Preferable the materials that are used to form the third layer 24 are selected from a group comprising of vinyl offal, or natural fiber offal.

The upper surface 30 of the fourth layer 26, is preferably attached to the third layer 24 and the lower surface 32 is preferably attached to the substrate 18. Suitable materials that are used to form the fourth layer 26 are preferably the same that are used to form second layer 22. Alternatively, different material may be used to form the second layer 24 and the fourth layer 26. It is also possible that the density of the second layer 22 is different from the density of the forth layer 26. However, it is preferable that the second layer 22 and the fourth layer 26 have the same thermoformable temperature. In the preferred embodiments the materials used to form the fourth layer 26 of the trim panel assembly is natural fiber mat or alternatively may be a mixture of natural fiber and polypropylene fiber.

As shown in FIG. 2, the cross section of the door panel insert 10 comprises a first layer 20 formed of extruded polypropylene or spun bond polypropylene, and a second layer 22 formed of a natural mat that is adaptable to be molded into a substrate. Additionally, the door panel insert 10 comprises a third layer 24 formed of a recyclate material and a fourth layer 26 formed of the same material as the second layer. Both the second layer 24 and the fourth layer 26 are adaptable of being molded such that a need for a separate substrate is substantially eliminated.

The method of forming the door panel insert 10 comprises forming a pre-form wherein the first layer 20, second layer 22, third layer 24 and the fourth layer 26 are individually formed. Additionally, the second layer 22 and the fourth layer 26 are molded into a hard substrate during the compression molding process such that the door panel insert 10 can be attached to the door panel substrate 18. The first step of forming the pre-form of the door panel insert 10 comprises forming the second layer 22 and the fourth layer 26. The process of forming the second layer 22 and the fourth layer 26 from natural fiber mat composites is well known in the art and not explained in details. Briefly stated, the fibers from natural sources such as hemp is mixed with polypropylene fibers with the help of a binder material. Typically, the fibers are chopped to a desired size and mixed with the polypropylene fibers. The binding material is then added to the mixture of natural fiber and the polypropylene fibers and heated such that mat having the desired thickness is formed. The recyclate material forming the third layer 24 is obtained in a granular form. The granular form of the third material is heated and dropped on the top surface 30 of the fourth layer 26. The second layer 22 is then tacked on top of the third layer 24, such that the third layer 24 is sandwiched between the second layer 22 and the fourth layer 26. Finally, the first layer 20 is added on the top surface of the second layer 22.

After the pre-form comprising the individual layers are formed, the door panel insert 10 is inserted inside a molding tool. The molding tool is well known in the art and is not described in detail. The door panel insert 10 is then subjected to compression molding and heating such that a chemical bond is formed between the polypropylene fibers in the natural mat of the second layer 22 and the polypropylene fibers in the first layer 20. After undergoing the heating and compression the door panel insert 10 is taken out of the molding tool and attached to the door panel substrate 18 by the heat staking. Alternatively, adhesives may be used to attach the door panel insert 10 to the door panel substrate 18.

In this invention, the introduction of the third layer 24 formed of a recylate material allows for the door panel insert 10 to be recylated once the door panel insert 10 is removed from the motor vehicle. Additionally, it also allows for a door panel insert 10 or a door panel 18 having greater strength and the elimination to add a separate coverskin material to form the class A surface. As explained above, this process may be used to form the door panel 18.

As any person skilled in the art will recognize from the previous description and from the figures and claims, modifications and changes can be made to the preferred embodiments of the invention without departing from the scope of the invention.

What is claimed is:

1. A vehicle trim panel installed in an interior of a motor vehicle, the trim panel comprising:
a first layer formed of a first material, such that the first layer is exposed to the interior of the motor vehicle;
a recyclate layer formed of a second material wherein the recyclate layer has a top surface and a bottom surface; and
a second layer formed of a third material positioned between the first layer and the top surface of the recyclate layer.

2. The trim panel of claim 1, wherein the trim panel further comprises a third layer disposed on the bottom surface of the recylate layer such that the recyclate layer is sandwiched between the second layer and the third layer.

3. The trim panel of claim 2, wherein the third layer is formed of the same material as the second layer.

4. The trim panel of claim 1, wherein density of the second layer is greater than the density of the first layer and the recyclate layer.

5. The trim panel of claim 1, wherein the first material is selected from a group comprising of extruded polypropylene or spun bond polypropylene.

6. The trim panel of claim 1, wherein the second material is selected from a group comprising of vinyl offal or natural fiber offal.

7. The trim panel of claim 1, wherein the third material is a natural fiber mat composite wherein the natural fiber mat composite comprises natural fibers mixed with polypropylene fibers.

8. The trim panel of claim 7, wherein the natural fibers are selected from a group comprising of kenaf, hemp, flax, jute or sisal.

9. The trim panel of claim 1, wherein the second layer of the trim panel forms the substrate.

10. A method of forming a trim panel attached to the interior of a motor vehicle, the trim panel having a first layer, a second layer, a third layer and a fourth layer, the method comprising:
forming the second layer and the fourth layer by mixing nature fibers with polypropylene fibers in presence of a binder material;
forming the third layer by granulating a recylate material and adding to a top surface of the fourth layer;
sandwiching the third layer between the second layer and the fourth layer;
forming the first layer from a first material;
tacking on the first layer to a top surface of the second layer;
forming a pre-form comprising the first layer, the second layer, the fourth layer and the third layer sandwiched between the second layer and the fourth layer;
inserting the pre-form into a molding tool;
molding the pre-form to form the trim panel such that a chemical bond is formed between the first layer and the second layer.

11. The method of claim 10, further comprising selecting the natural fibers from a group consisting of kenaf, flax, jute or sisal.

12. The method of claim 10, further comprising selecting the recylate material from a group consisting of vinyl offal or natural fiber offal.

13. The method of claim 10, wherein the first material is selected from a group comprising of extruded polypropylene or spun bond polypropylene.

14. The method of claim 10, further comprising wherein during the step of molding of the pre-form the second layer and the fourth layer are compression molded such that the fourth layer is adaptable to be attached to an interior metal sheet of the motor vehicle.
